(19) United States
(12) Patent Application Publication
(10) Pub. No.: US 2026/0008175 A1
(43) Pub. Date: Jan. 8, 2026

(54) Extended-Reach High-Throughput Material-Handling Robot

(71) Applicant: Persimmon Technologies Corporation, Wakefield, MA (US)

(72) Inventors: Martin Hosek, Salem, NH (US); Scott Wilkas, Lexington, MA (US)

(21) Appl. No.: 19/262,564

(22) Filed: Jul. 8, 2025

Related U.S. Application Data
(60) Provisional application No. 63/668,470, filed on Jul. 8, 2024.
(60) Provisional application No. 63/736,183, filed on Dec. 19, 2024.

(51) Int. Cl. B25J 9/10; B25J 9/12; B25J 11/00; B25J 15/00

(52) U.S. Cl. CPC B25J 9/106; B25J 9/104; B25J 9/126; B25J 11/0095; B25J 15/0014

(57) ABSTRACT

An apparatus includes a robot drive comprising a plurality of coaxial drive shafts, each of the coaxial drive shafts being independently driven by a respective motor; an arm connected to the robot drive and rotatable on the robot drive, the arm comprising a first linkage and a second linkage; and a controller configured to control the respective motors driving the coaxial drive shafts. The respective motors are controlled to drive the coaxial drive shafts to cause the second linkage, in a retracted position, to be rotated out of the way of the first linkage at a same time as the first linkage is extended.

### CROSS REFERENCE

This application claims priority under 35 USC 119 (e) to U.S. Provisional Application No. 63/668,470, filed Jul. 8, 2024, and U.S. Provisional Application No. 63/736,183, filed Dec. 19, 2024, both of which are hereby incorporated by reference in their entireties.

### BACKGROUND

### Technical Field

The example and non-limiting embodiments relate generally to material-handling robots, and, more particularly, to a material-handling robot having extended-reach capabilities.

### Brief Description of Prior Developments

Robot arms with multiple linkages (for example, two-linkage robot arms) may employ different types of robot arm architectures. The various s types of robot arm architectures may involve bridge structures or the like, suspension-type configurations, or they may use butterfly-type of arrangements.

### SUMMARY

The following summary is merely intended to be exemplary. The summary is not intended to limit the scope of the claims.

In accordance with one aspect, an apparatus comprises a robot drive comprising a plurality of coaxial drive shafts, each of the coaxial drive shafts being independently driven by a respective motor; an arm connected to the robot drive and rotatable on the robot drive, the arm comprising a first linkage comprising a first upper arm, a first forearm connected to the first upper arm, and a first end effector connected to the first forearm, the first upper arm connected to a first drive shaft of the coaxial drive shafts at a shoulder joint, the first forearm connected to a first shoulder pulley on the second drive shaft of the coaxial drive shafts, the first forearm having a first elbow pulley, the first elbow pulley connected to the first shoulder pulley through a first belt drive arrangement, wherein a ratio of diameters of the first shoulder pulley and the first elbow pulley is greater than 2:1, and the first end effector connected to the first forearm at a first wrist pulley, the first wrist pulley connected to the first upper arm at a second elbow pulley, the first wrist pulley connected to the second elbow pulley through a second belt drive arrangement, wherein a ratio of diameters of the second elbow pulley and the first wrist pulley is 1:2; and a second linkage comprising a second upper arm, a second forearm connected to the second upper arm, and a second end effector connected to the second forearm, the second upper arm connected to a third drive shaft of the coaxial drive shafts at the shoulder joint, the second forearm connected to a second shoulder pulley on the second drive shaft of the coaxial drive shafts, the second forearm having a third elbow pulley, the third elbow pulley connected to the second shoulder pulley through a third belt drive arrangement, wherein a ratio of diameters of the second shoulder pulley and the third elbow pulley is 2:1, and the second end effector connected to the second forearm at a second wrist pulley, the second wrist pulley connected to the second upper arm at a fourth elbow pulley, the second wrist pulley connected to the fourth elbow pulley through a fourth belt drive arrangement, wherein a ratio of diameters of the fourth elbow pulley and the second wrist pulley is 1:2; and a controller configured to control the respective motors driving the coaxial drive shafts, wherein the respective motors are controlled to drive the coaxial drive shafts to cause the second linkage, in a retracted position, to be rotated at a same time as the first linkage is extended.

In accordance with another aspect, an apparatus comprises a robot drive comprising a first drive shaft, a second drive shaft, and a third drive shaft, the drive shafts each being coaxially arranged and independently drivable by a respective motor; an arm connected to the robot drive and rotatable about the robot drive, the arm comprising, a first linkage comprising a first upper arm, a first forearm connected to the first upper arm, and a first end effector connected to the first forearm, a second linkage comprising a second upper arm, a second forearm connected to the second upper arm, and a second end effector connected to the second forearm; at least one processor; and at least one memory storing instructions that, when executed with the at least one processor, cause the apparatus to: rotate the first drive shaft in a first direction synchronously with the second drive shaft in the first direction as a function of the rotation of the first drive shaft; and rotate the third drive shaft synchronously with the second drive shaft, to cause a rotation of the second linkage, in a retracted position, out of the way of the first linkage, wherein the rotation of the second linkage allows for a clearance of the first linkage relative to the second linkage during an extension of the first linkage.

In accordance with another aspect, an apparatus comprises a robot drive comprising a first drive shaft, a second drive shaft, and a third drive shaft, the drive shafts being and coaxially arranged each being independently drivable by a respective motor in first and second directions; an arm connected to the robot drive and rotatable about the robot drive, the arm comprising, a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and a second linkage coupled to the robot drive at a second shoulder pulley, the second linkage comprising a second upper arm, a second forearm connected to the second upper arm at a second elbow pulley, a second belt arrangement between the second shoulder pulley and the second elbow, and a second end effector connected to the second forearm at a second wrist; at least one processor; and at least one memory storing instructions that, when executed with the at least one processor, cause the apparatus to: rotate the first drive shaft in a first direction synchronously with the second drive shaft in the first direction as a function of the rotation of the first drive shaft to drive the first belt arrangement to extend the first linkage from a retracted position; and rotate the third drive shaft, simultaneously and synchronously with the second drive shaft in the second direction, to cause a rotation of the second linkage, in a retracted position, out of the way of the first linkage, wherein the rotation of the second linkage allows for a clearance of the first linkage relative to the second linkage as the first linkage extends from the retracted position.

In accordance with another aspect, a method comprises providing a robot drive comprising a first drive shaft, a second drive shaft, and a third drive shaft, the drive shafts being coaxially arranged and each being independently drivable by a respective motor in first and second directions, an arm connected to the robot drive and rotatable about the robot drive, the arm comprising, a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and a second linkage coupled to the robot drive at a second shoulder pulley, the second linkage comprising a second upper arm, a second forearm connected to the second upper arm at a second elbow pulley, a second belt arrangement between the second shoulder pulley and the second elbow pulley, and a second end effector connected to the second forearm at a second wrist; rotating the first drive shaft in a first direction synchronously with the second drive shaft in the first direction as a function of the rotation of the first drive shaft to drive the first belt arrangement to extend the first linkage from a retracted position; and rotating the third drive shaft synchronously with the second drive shaft in the second direction to cause a rotation of the second linkage, in a retracted position, out of the way of the first linkage, wherein the rotation of the second linkage allows for a clearance of the first linkage relative to the second linkage at the first elbow pulley, simultaneously with an extension of the first linkage.

### BRIEF DESCRIPTION OF THE DRAWINGS

The foregoing aspects and other features are explained in the following description, taken in connection with the accompanying drawings, wherein:

FIG. 1A is a top view of one example embodiment of a robot;

FIG. 1B is a side view of the example robot of FIG. 1A;

FIG. 2 is a side view of the example robot of FIG. 1A and FIG. 1B illustrating exemplary internal arrangements;

FIGS. 3A-3C are schematic illustrations of extended and retracted positions of the linkages of the robot;

FIGS. 4A-4E are schematic illustrations of phased motions of the example embodiment of the robot;

FIG. 5A is a top view of another example robot in which links of the linkages of the robot are alternately arranged;

FIG. 5B is a side view of the example robot of FIG. 5A;

FIG. 6A is a top view of another example robot in which linkages of the robot are configured to carry a single wafer;

FIG. 6B is a side view of the example robot of FIG. 6A;

FIGS. 7A-7C are schematic illustration of extended and retracted positions of the robot of FIGS. 6A and 6B;

FIGS. 8A-8E are schematic illustrations of phased motions of an example dual-linkage robot in which one linkage is extended without rotation of a second linkage;

FIGS. 8F-8J are schematic illustrations of phased motions of the robot of FIG. 2 in which one linkage is extended while a second linkage is rotated slightly;

FIGS. 9A-9D are graphical representations of changes in angular orientation of a second linkage and shafts as functions of normalized changes in radial extension of a first linkage; and

FIGS. 10A-10D are graphical representations of changes in angular orientation of a first linkage and shafts as functions of normalized changes in radial extension of a second linkage.

### DETAILED DESCRIPTION

The present invention describes examples of semiconductor manufacturing tools that utilize robotic systems to transfer material, such as silicon wafers or other workpieces, in clean and vacuum environments. The robotic systems often utilize robot arms with two linkages so that a processed wafer or a set of processed wafers can be retrieved from a process station by one linkage and replaced rapidly by a fresh wafer or set of fresh wafers readily available on the other linkage of the robot arm in a material exchange operation. By retrieving and rapidly replacing the wafers, the throughput or number of wafers processed per hour may be increased, which is an overall increase in the productivity of the semiconductor manufacturing tool.

Robot arms with two linkages (two-linkage robot arms) may be based on one of various robot arm architectures. One type of architecture may be a two-linkage arm with independently extending linkages where the upper end-effector or a set of upper end-effectors is supported by a bridge structure reaching around the lower end-effector or a set of lower end-effectors (two-linkage arm with independently extending linkages). Another type of architecture may be a two-linkage arm with independently extending linkages where the upper end-effector or a set of upper end-effectors are suspended from the forearm (second link) of one of the two linkages (two-linkage arm with independently extending linkages). Still another type of architecture may be a butterfly two-linkage arm.

With regard to the two-linkage arm architecture employing the bridge structure, the bridge structure of the two-linkage arm with independently extending linkages occupies space, which limits how far back the linkage with the bridge structure can retract, thus limiting the maximum length of the end-effector or end-effectors. This in turn limits the reach when the linkage is extended.

Furthermore, the bridge structure adds weight, which limits the acceleration of the linkage, and may compromise the structural stiffness, which increases deflection and vibration.

With regard to the architecture of the two-linkage arm with independently extending linkages, this architecture generally features skewed linkages, i.e., there is a nonzero angle between the directions of extension of the two linkages, in order to avoid interference of the elbow joint of one of the linkages with the end-effector(s) of the other linkage and/or the wafer(s) on the end-effectors of the other linkage. As a result, the orientation of the robot arm should be adjusted between retraction of one linkage and extension of the other linkage, which adds time to the material exchange operation, thus limiting the throughput (the number of wafers processed per hour) and productivity of the semiconductor manufacturing tool.

In the butterfly two-linkage arm architecture, the two linkages are coupled through rigidly connected upper arms (first links) of the two linkages. As a result, when extending or retracting one linkage, the other linkage rotates, which in turn slows the extending or retracting linkage. This is because the rotating linkage typically carries a wafer (or a set of wafers) during a material exchange operation, and the speed and acceleration of the rotational motion is preferably limited so that wafer slippage does not occur.

The material-handling robot of the present invention described below addresses the shortcomings of the above-described two-linkage robot arms.

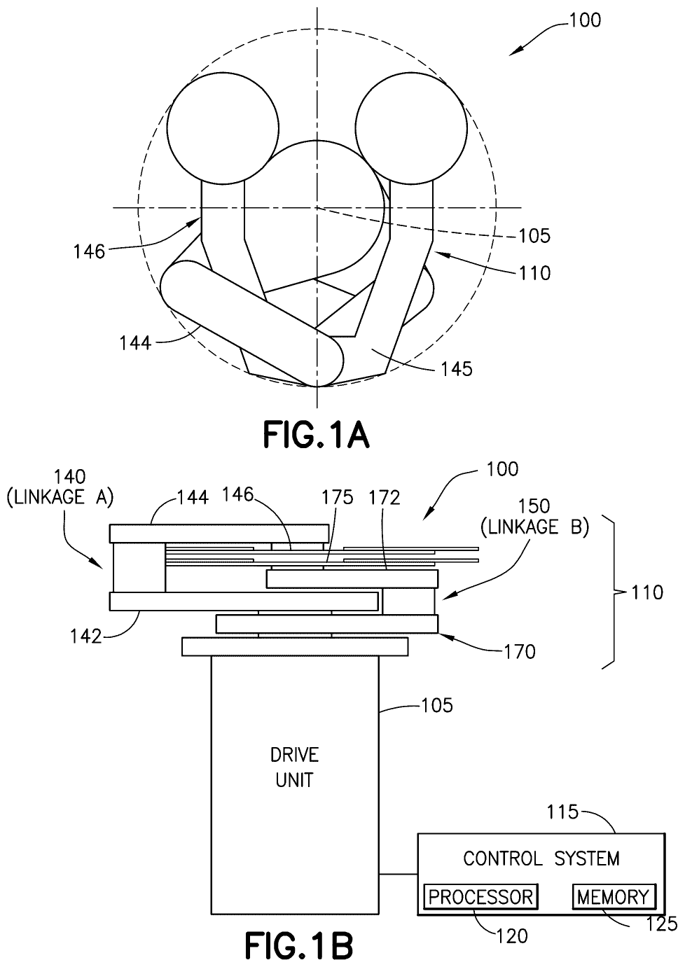

Referring to FIGS. 1A and 1B, one example of a material-handling robot having extended-reach capabilities is depicted generally at 100. Robot 100 includes a drive unit 105, a robot arm 110 rotatably coupled to the drive unit 105, and a controller or control system 115 having at least one processor 120 and at least one memory 125. The at least one memory 125 stores instructions that, when executed with the at least one processor 120, cause the control system 115 to direct the robot 100 to carry out operations.

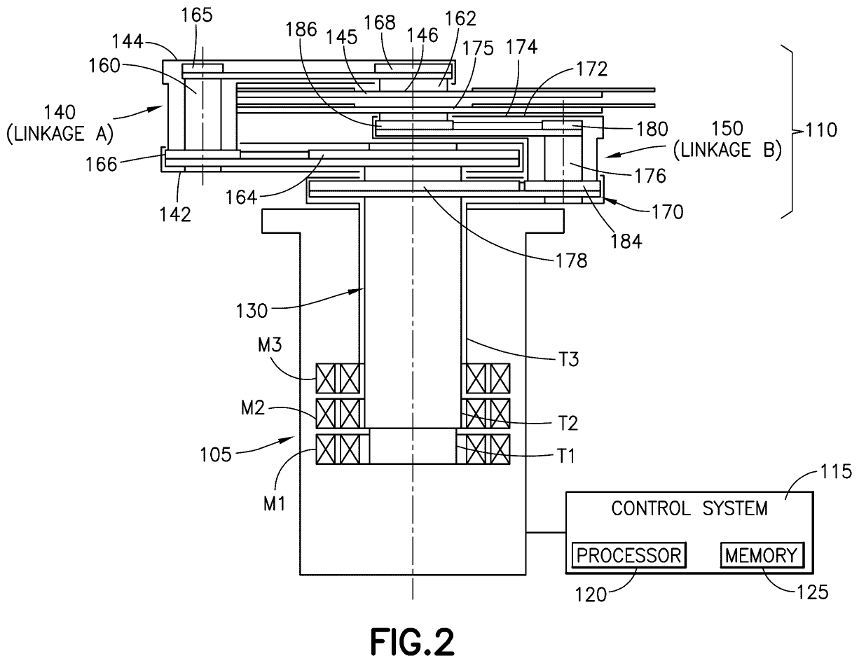

Referring to FIG. 2, the drive unit 105 may include a three-axis spindle 130 having three coaxial shafts, namely, an inner shaft T1, a shaft T2, and an outer shaft T3, each shaft being actuated by its own electric motor M1, M2, and M3, respectively, to move the robot arm 110. The drive unit 105 may further include a lift mechanism (for example, a frame movable in vertical directions using a screw or the like) configured to vertically move the spindle 130.

Still referring to FIG. 2, the robot arm 110 may include two linkages, namely, a first linkage 140 (linkage A) and a second linkage 150 (linkage B). The first linkage 140 (linkage A) may include an upper arm 142, a forearm 144, and a wrist plate 145 having at least one end-effector 146 depending therefrom, the upper arm 142, the forearm 144, and the wrist plate 145 being serially connected. The forearm 144 may be coupled to the upper arm 142 with a rotary joint 160, which forms an elbow (elbow joint). Similarly, the wrist plate 145 may be coupled to the forearm 144 with a second rotary joint 162, which forms a wrist (wrist joint).

The upper arm 142 of the first linkage 140 may be connected directly to shaft T1 of the drive unit 105 at a shoulder joint. The forearm 144 may be coupled to shaft T2 of the drive unit 105 through a belt drive arrangement which may include a shoulder pulley 164 connected to shaft T2, an elbow pulley 165 connected to the forearm 144, and a band, belt, or cable forming a belt drive arrangement that is utilized to transmit motion between the shoulder pulley 164 and the elbow pulley 165. A transmission ratio of the belt drive arrangement, for example, a ratio of the diameter of the shoulder pulley 164 and the diameter of the elbow pulley 165, may be greater than 2:1.

The orientation of the wrist plate 145 with the end-effectors 146 depending therefrom may be constrained to maintain a substantially radial direction with respect to the shoulder joint with a belt drive arrangement which may include a second elbow pulley 166 connected to the upper arm 142, a wrist pulley 168 connected to the wrist plate 145, and a band, belt, or cable forming another belt drive arrangement utilized to transmit motion between the second elbow pulley 166 and the wrist pulley 168. A transmission ratio of the belt drive arrangement, for example, a ratio of the diameter of the second elbow pulley 166 and the diameter of the wrist pulley 168, may be 1:2.

In a manner similar to the first linkage 140 (linkage A), the second linkage 150 (linkage B) may include an upper arm 170, a forearm 172, and a wrist plate 174 having at least one end-effector 175 depending therefrom, the upper arm 170, the forearm 172, and the wrist plate 174 being serially connected. The forearm 172 may be coupled to the upper arm 170 with a third rotary joint 176, which forms another elbow joint. Similarly, the wrist plate 174 with the end-effectors 175 may be coupled to the forearm 172 with a fourth rotary joint (wrist joint).

The upper arm 170 of the second linkage (linkage B) may be connected directly to shaft T3 of the drive unit 105. The forearm 172 may be coupled to shaft T2 of the drive unit 105 through a belt drive arrangement which may include a second shoulder pulley 178 connected to shaft T2, a second elbow pulley 180 connected to the forearm 172, and a band, belt, or cable utilized to transmit motion between the second shoulder pulley 178 and the second elbow pulley 180. A transmission ratio of the belt drive arrangement, for example, the ratio of the diameter of the second shoulder pulley 178 and the diameter of the second elbow pulley 180, may be equal to 2:1.

The orientation of the wrist plate 174 with end-effectors 175 may be constrained to maintain substantially radial direction with respect to the shoulder joint with a belt drive arrangement which may include another elbow pulley 184 connected to the upper arm 170, another wrist pulley 186 connected to the wrist plate 174, and a band, belt, or cable forming another belt drive arrangement utilized to transmit motion between the two pulleys 184, 186. A transmission ratio of the belt drive arrangement, for example, a ratio of the diameter of the another elbow pulley 184 and the diameter of the another wrist pulley 186, may be 1:2.

The control system 115 includes hardware and software configured to control the motors associated with shafts T1, T2, and T3 of the drive unit 105 to extend and retract the first linkage 140 (linkage A) along a desired trajectory, such as a radial straight line, to extend and retract the second linkage 150 (linkage B) along a desired trajectory, such as a radial straight line, and to rotate the robot arm 110, including both the first and second linkages 140,150 (linkage A and linkage B), by a specified angle. The control system 115 may further be configured to control the lift mechanism of the drive unit 105.

In order to extend the first linkage 140 (linkage A) along a straight line, the control system 115 may cause rotation of shaft T1 in the clockwise direction while simultaneously rotating shaft T2 in the clockwise direction as a function of rotation of shaft T1 based on kinematic equations associated with the first linkage 140 (linkage A). At the same time, the control system 115 may cause the rotation of shaft T3 in synchronization with shaft T2, as a result of which the second linkage 150 (linkage B) may rotate out of the way of the first linkage 140 (linkage A) while the first linkage 140 (linkage A)) maintains its initial extension. In some embodiments, the second linkage 150 (linkage B) remains retracted as the first linkage 140 (linkage A) extends.

In order to extend the second linkage 150 (linkage B) along a straight line, the control system 115 may cause the rotation of shaft T3 in the counterclockwise direction while keeping shaft T2 stationary. At the same time, the control system 115 may keep shaft T1 also stationary, as a result of which the first linkage 140 (linkage A) may stay stationary while keeping its initial extension. In some embodiments, the first linkage 140 (linkage A) remains retracted as the second linkage 150 (linkage B).

In order to rotate the entire arm, including the first linkage 140 (linkage A) and the second linkage 150 (linkage B), the control system 115 may rotate shafts T1, T2, and T3 simultaneously and in synchronization by the desired amount in the desired direction of rotation.

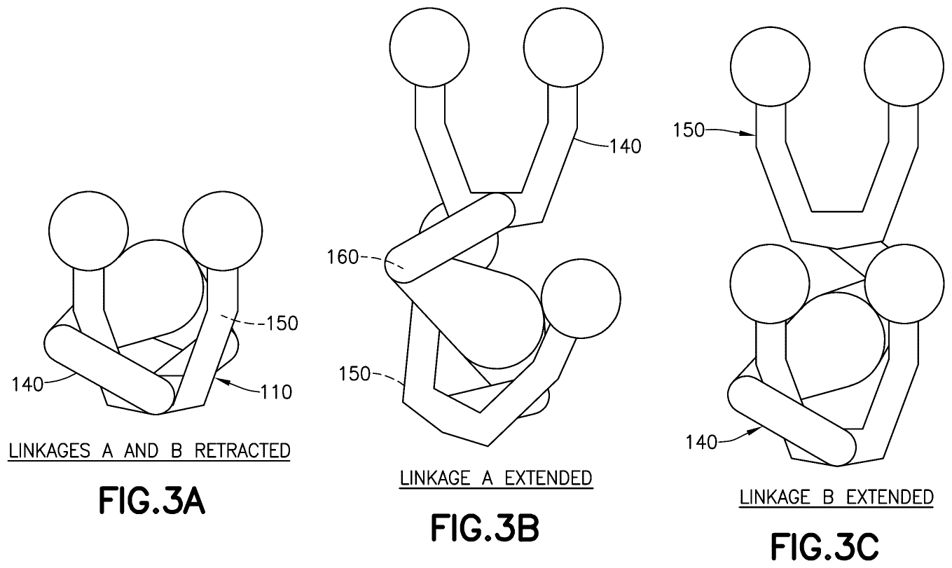

Referring now to FIGS. 3A-3C, the above-described operation of the robot 100 is illustrated. As shown in FIG. 3A, the robot 100 with the first linkage 140 (linkage A) and the second linkage 150 (linkage B) retracted is shown with the second linkage 150 being underneath the first linkage 140. In FIG. 3B, the robot 100 is shown with the first linkage 140 (linkage A) extending, while the second linkage 150 (linkage B) is rotated while in the retracted position of FIG. 3A in a clockwise direction enough to provide clearance for the elbow joint at the rotary joint 160 in the first linkage 140 (linkage A). FIG. 3C shows the robot with the second linkage 150 (linkage B) extended, while the first linkage 140 (linkage A) is stationary with respect to the retracted position of the first linkage 140 (linkage A) and the second linkage 150 (linkage B) as shown in FIG. 3A.

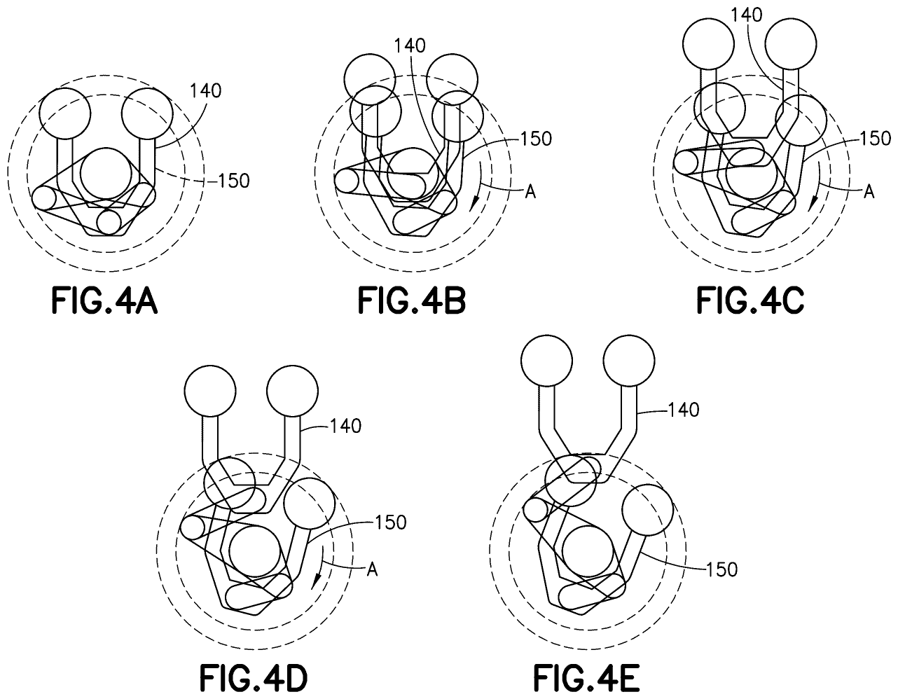

Referring now to FIGS. 4A-4E, illustrations of phased motion of the robot 100 are shown. In FIG. 4A, the first linkage 140 (linkage A) and the second linkage 150 (linkage B) are retracted. As shown in FIG. 4B, the second linkage 150 (linkage B) begins to gradually rotate away from the elbow joint of the first linkage 140 (linkage A) in the direction indicated by arrow A as the first linkage 140 (linkage A) extends, due to the synchronized rotation of the shafts based on the kinematic equations associated with linkage A and the minimum rotation of one shaft relative to the other to allow the second linkage 150 to rotate out of the way of the elbow joint of the first linkage 140. FIG. 4C shows the second linkage 150 (linkage B) further rotated away in the direction indicated by arrow A, and FIG. 4D shows the second linkage 150 (linkage B) further rotated and the first linkage 140 further extended. FIG. 4E shows the second linkage 150 (linkage B) fully rotated and the first linkage 140 (linkage A) fully extended.

Although the second linkage 150 (linkage B) as shown in FIGS. 4A-4E utilizes a transmission ratio of 2:1 of the belt drive between the shoulder pulley 178 connected to shaft T2 and the elbow pulley 180 connected to the forearm 172, any transmission ratio greater than or equal to 2 may be utilized. When the transmission ratio is greater than 2, the first linkage 140 (linkage A) rotates when the second linkage 150 (linkage B) extends along a straight line.

Also, although the linkages of FIGS. 4A-4E are shown as linkages with substantially equal link length and substantially circular pulleys, unequal link lengths and noncircular pulleys can be utilized in any or all of the linkages.

Furthermore, alternate stackings of the linkages may be used. For example, although the example embodiment of the robot 100 is shown in a configuration where the links of the linkages are stacked top-down as 144, 146, 175, 172, 142, 170, any suitable order of the links can be used. For example, the links can be stacked as 144, 146, 175, 172, 170, 142 or 146, 144, 175, 172, 142, 170 or 146, 144, 175, 172, 170, 142.

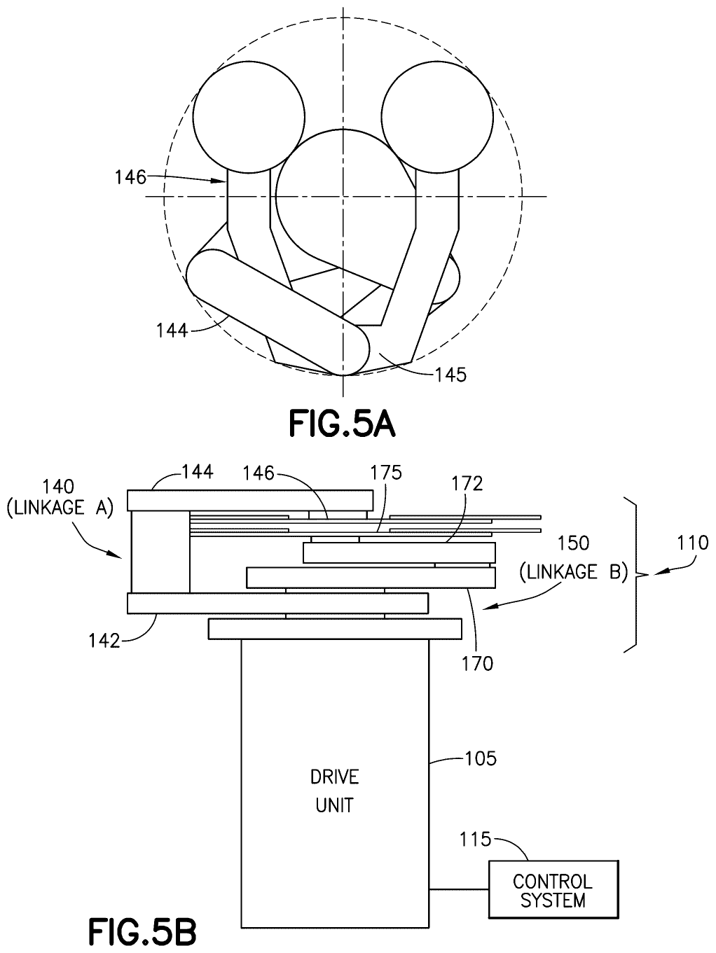

Referring now to FIGS. 5A and 5B, an alternate order of the stacking of the links is shown. In this example embodiment, shafts T1 and T3 exchange their roles (as shaft T1 may be connected to the upper arm 170, and shaft T2 may be connected to the upper arm 142).

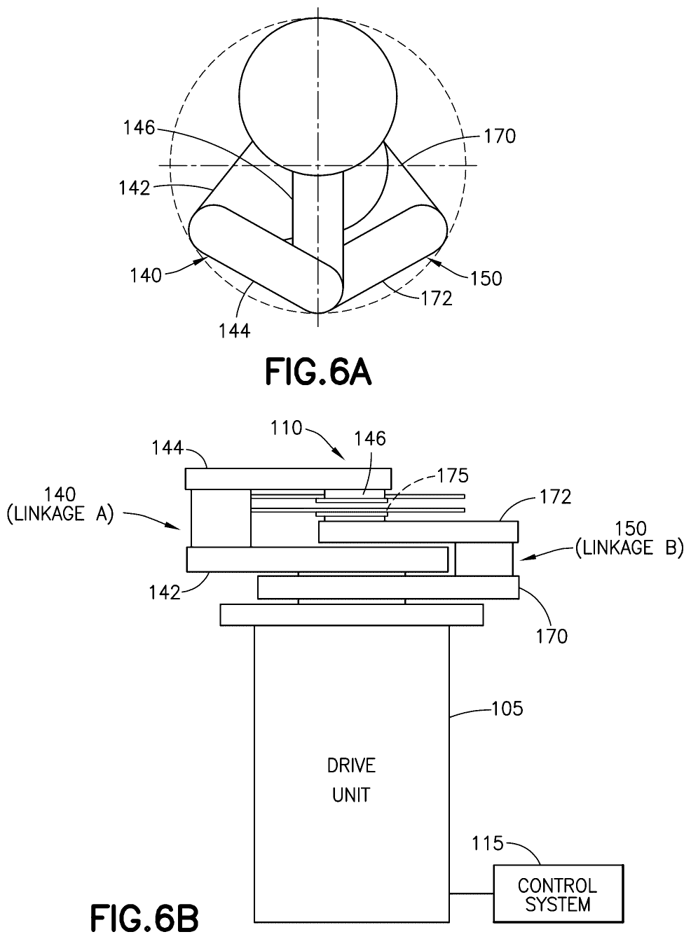

Although the linkages of the above example embodiments of the robot 100 may be configured to carry a pair of wafers using a wrist plate with two end effectors depending therefrom in a forked configuration, it should be noted that each linkage can carry any suitable number of wafers, including a single wafer. Referring now to FIGS. 6A and 6B, one example embodiment where each of the linkages (a first linkage 140 (linkage A) and a second linkage 150 (linkage B)) comprises a single arm that is configured to carry a single wafer is shown diagrammatically. FIG. 6A shows a top view of an example robot 100 in which the end effector 146 is configured to carry the single wafer, and FIG. 6B shows a side view of the robot 100.

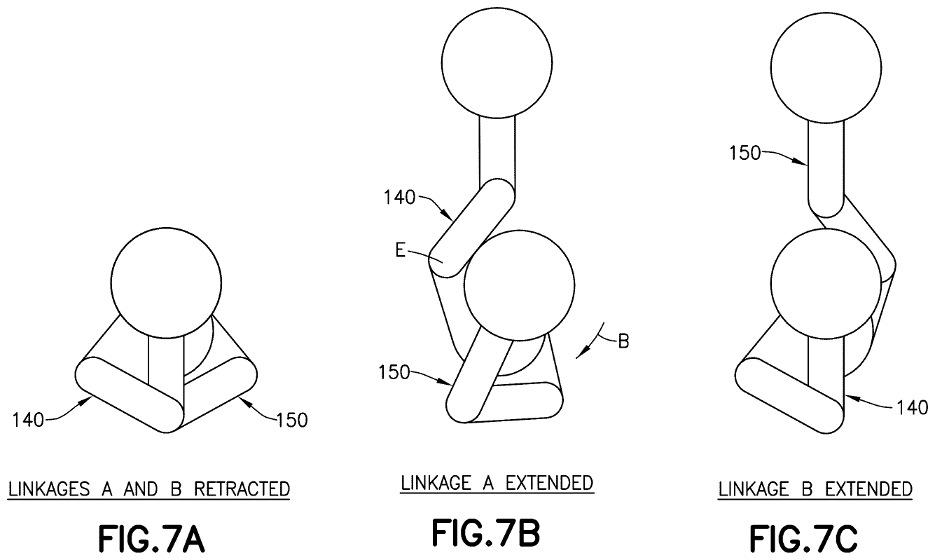

Referring to FIGS. 7A-7C, one example operation of the robot 100 of FIGS. 6A and 6B is shown. As shown in FIG. 7A, the robot 100 is shown with the first linkage 140 (linkage A) and the second linkage 150 (linkage B) retracted. Portions of the first linkage 140 (linkage A) are positioned above portions of the second linkage 150 (linkage B). In particular, the end effectors are positioned one over the other. As shown in FIG. 7B, the first linkage 140 (linkage A) of the robot 100 is extended. In such a configuration, the second linkage 150 (linkage B) is rotated in the direction of arrow B from the retracted position of FIG. 7A enough to provide clearance for the elbow joint (shown at E) of the first linkage 140 (linkage A). In FIG. 7C, the second linkage 150 (linkage B) is extended, and the first linkage 140 (linkage A) remains stationary with respect to the retracted position as shown in FIG. 7A.

Although the control systems are shown as being external to the drive units in the above examples, it should be understood that the control systems (may be integrated partially or fully into the drive units of the respective robots.

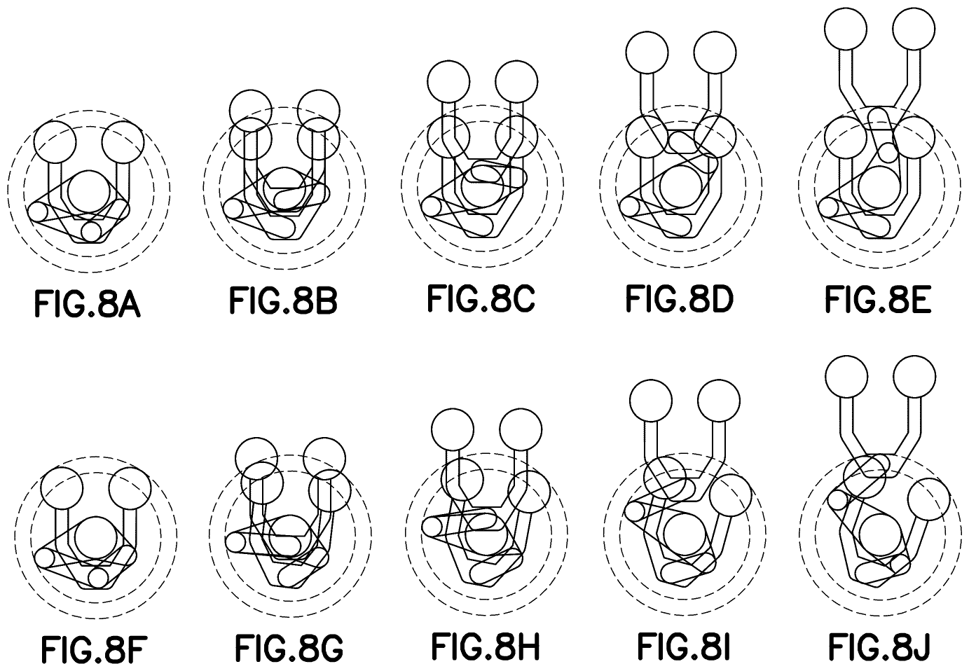

Referring now to FIGS. 8A-8J, additional phased motions of other configurations of the example robots described above, for example, robot configurations having no skew and increased pulley ratio extend/retract abilities. FIGS. 8A-8E illustrate the phased motions of an example dual-linkage robot in which one linkage is extended without rotation of a second linkage. In such a case, the reach of the extending linkage may be limited, or a bridge structure is used, which may add weight to the robot and/or inhibit the speeds at which the linkages are extended and retracted.

FIGS. 8F-8J illustrate the phased motions of the example robots as described herein in which the one linkage is extended in synchronization with a minimal or small rotation of a second linkage to allow clearance for the elbow joint, which may extend the reach of the extending linkage and/or facilitate faster extension and retraction. As shown in FIG. 8J, the extended linkage has the same reach as the extended linkage in FIG. 8E, but as can be seen from the positions of the linkages, it may be possible to extend the extended linkage further.

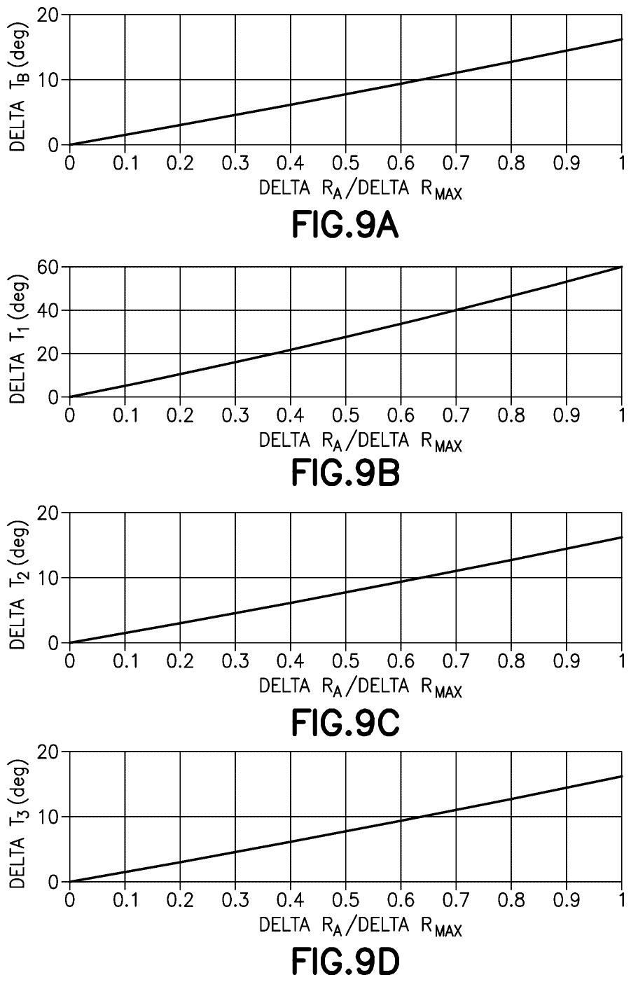

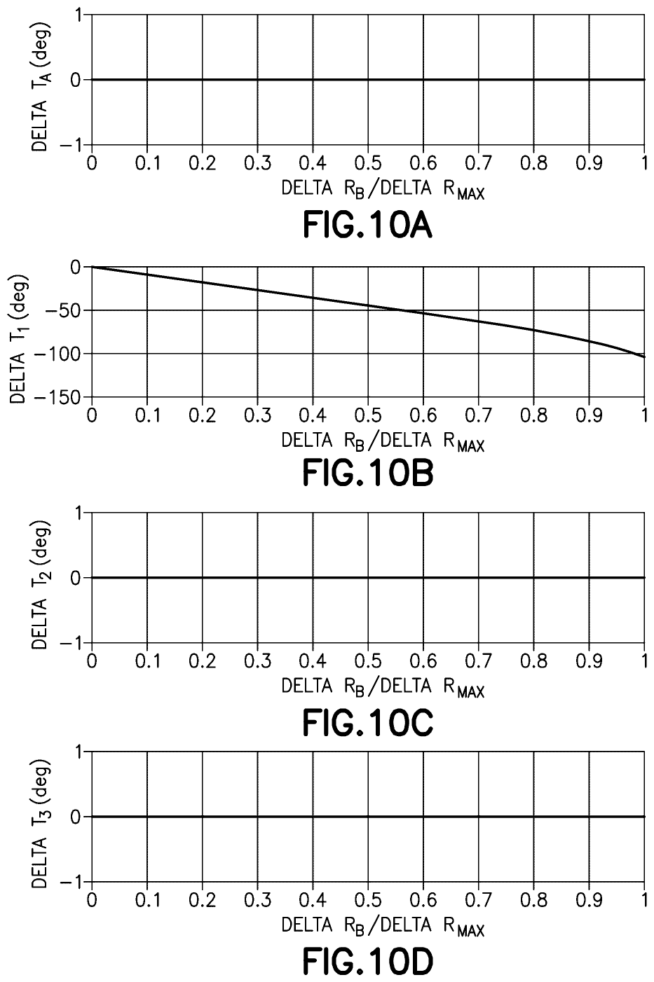

In order to further explain the operation of the robot arm according to the present invention, example radial extension moves of linkages A and B are illustrated graphically in FIGS. 9A-9D and 10A-10D. One example of a robot arm (for example, robot arm 110) with the following properties is considered: L_{A}=0.400 meters (m), L_{B}=0.260 m, L_{3A}=0.630 m, L_{3B}=0.630 m, and n_{A}=2.75 m, where:
L_{A} is the joint-to-joint length of upper arm and forearm of linkage A;
L_{B} is the joint-to-joint length of upper arm and forearm of linkage B;
L_{3A} is the distance between the wrist joint and a reference point which defines a position of linkage A in a polar coordinate system (for example, the reference point may be a center point between the two payloads carried by linkage A);
L_{3B} is the distance between the wrist joint and a reference point which defines a position of linkage B in a polar coordinate system (for example, the reference point may be a center point between the two payloads carried by linkage B); and
n_{A} is the ratio of the diameter of the shoulder puller of linkage A and the corresponding elbow pulley of linkage A.

Referring now to FIGS. 9A-9D, linkage A extends radially from an initial retracted position RINI of 0.335 m by a radial distance (stroke) Delta RMAX of 0.785 m. FIGS. 9A-9D depict the change in angular orientation of linkage B (Delta TB); the change in angular orientation of shaft 1 (Delta T1); the change in angular orientation of shaft 2 (Delta T2); and the change in angular orientation of shaft 3 (Delta T3); as a function of normalized change in the radial extension of linkage A.

Referring now to FIGS. 10A-10D, linkage B extends radially from the same initial retracted position RINI of 0.335 m by the same radial distance (stroke) Delta RMAX of 0.785 m. FIGS. 10A-10D depict the change in angular orientation of linkage A (Delta TA); the change in angular orientation of shaft 1 (Delta T1); the change in angular orientation of shaft 2 (Delta T2); and the change in angular orientation of shaft 3 (Delta T3); as a function of normalized change in the radial extension of linkage B.

In one example embodiment, an apparatus comprises a robot drive comprising a plurality of coaxial drive shafts, each of the coaxial drive shafts being independently driven by a respective motor; an arm connected to the robot drive and rotatable on the robot drive, the arm comprising a first linkage comprising a first upper arm, a first forearm connected to the first upper arm, and a first end effector connected to the first forearm, the first upper arm connected to a first drive shaft of the coaxial drive shafts at a shoulder joint, the first forearm connected to a first shoulder pulley on the second drive shaft of the coaxial drive shafts, the first forearm having a first elbow pulley, the first elbow pulley connected to the first shoulder pulley through a first belt drive arrangement, wherein a ratio of diameters of the first shoulder pulley and the first elbow pulley is greater than 2:1, and the first end effector connected to the first forearm at a first wrist pulley, the first wrist pulley connected to the first upper arm at a second elbow pulley, the first wrist pulley connected to the second elbow pulley through a second belt drive arrangement, wherein a ratio of diameters of the second elbow pulley and the first wrist pulley is 1:2; and a second linkage comprising a second upper arm, a second forearm connected to the second upper arm, and a second end effector connected to the second forearm, the second upper arm connected to a third drive shaft of the coaxial drive shafts at the shoulder joint, the second forearm connected to a second shoulder pulley on the second drive shaft of the coaxial drive shafts, the second forearm having a third elbow pulley, the third elbow pulley connected to the second shoulder pulley through a third belt drive arrangement, wherein a ratio of diameters of the second shoulder pulley and the third elbow pulley is 2:1, and the second end effector connected to the second forearm at a second wrist pulley, the second wrist pulley connected to the second upper arm at a fourth elbow pulley, the second wrist pulley connected to the fourth elbow pulley through a fourth belt drive arrangement, wherein a ratio of diameters of the fourth elbow pulley and the second wrist pulley is 1:2; and a controller configured to control the respective motors driving the coaxial drive shafts, wherein the respective motors are controlled to drive the coaxial drive shafts to cause the second linkage, in a retracted position, to be rotated at a same time as the first linkage is extended.

The coaxial drive shafts may be configured such that a synchronized rotation of the first drive shaft in a first direction with the second drive shaft in the first direction as a function of the rotation of the first drive shaft, with a rotation of the third drive shaft in synchronization with the second drive shaft, causes a rotation of the second linkage, in a retracted position, about the drive unit, out of the way of the first linkage, to allow for an extension of the first linkage. A rotation of the third drive shaft in a second direction opposite the first direction while maintaining the first drive shaft and the second drive shaft stationary may cause the second linkage to extend while the first linkage is extended. The arm may be configured to be rotated about the drive unit by a simultaneous rotation of the coaxial drive shafts in a desired direction of rotation. The first end effector may comprise a first wrist plate connected to the first forearm at the pulley, and the second end effector may comprise a second wrist plate connected to the second forearm at the second wrist pulley. At least one of the first end effector or the second effector may comprise a forked configuration to accommodate two or more workpieces. At least one of the first end effector or the second end effector may comprise a single arm configured to carry a single workpiece. Links of the first linkage and links of the second linkage may be of substantially equal lengths.

In another example embodiment, an apparatus comprises a robot drive comprising a first drive shaft, a second drive shaft, and a third drive shaft, the drive shafts each being coaxially arranged and independently drivable by a respective motor; an arm connected to the robot drive and rotatable about the robot drive, the arm comprising, a first linkage comprising a first upper arm, a first forearm connected to the first upper arm, and a first end effector connected to the first forearm, a second linkage comprising a second upper arm, a second forearm connected to the second upper arm, and a second end effector connected to the second forearm; at least one processor; and at least one memory storing instructions that, when executed with the at least one processor, cause the apparatus to: rotate the first drive shaft in a first direction synchronously with the second drive shaft in the first direction as a function of the rotation of the first drive shaft; and rotate the third drive shaft synchronously with the second drive shaft, to cause a rotation of the second linkage, in a retracted position, out of the way of the first linkage, wherein the rotation of the second linkage allows for a clearance of the first linkage relative to the second linkage during an extension of the first linkage.

The instructions, when executed with the at least one processor, may cause the apparatus to rotate the third drive shaft in a second direction while maintaining the first drive shaft and the second drive shaft stationary, to cause the second linkage to extend while the first linkage is extended. The instructions, when executed with the at least one processor, may cause a rotation of the arm about the drive unit by a simultaneous rotation of the coaxial drive shafts in a desired direction of rotation.

In another example embodiment, an apparatus comprises a robot drive comprising a first drive shaft, a second drive shaft, and a third drive shaft, the drive shafts being coaxially being arranged and each independently drivable by a respective motor in first and second directions; an arm connected to the robot drive and rotatable about the robot drive, the arm comprising, a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and a second linkage coupled to the robot drive at a second shoulder pulley, the second linkage comprising a second upper arm, a second forearm connected to the second upper arm at a second elbow pulley, a second belt arrangement between the second shoulder pulley and the second elbow, and a second end effector connected to the second forearm at a second wrist; at least one processor; and at least one memory storing instructions that, when executed with the at least one processor, cause the apparatus to: rotate the first drive shaft in a first direction synchronously with the second drive shaft in the first direction as a function of the rotation of the first drive shaft to drive the first belt arrangement to extend the first linkage from a retracted position; and rotate the third drive simultaneously and synchronously with the second drive shaft in the second direction, to cause a rotation of the second linkage, in a retracted position, out of the way of the first linkage, wherein the rotation of the second linkage allows for a clearance of the first linkage relative to the second linkage as the first linkage extends from the retracted position.

The instructions, when executed with the at least one processor, may cause rotation of the first shoulder pulley to drive the first belt arrangement to drive the first elbow pulley on the first linkage, the rotation of the first shoulder pulley and the first elbow pulley causing the extension of the first linkage. The instructions, when executed with the at least one processor, may cause rotation of the second shoulder pulley to drive the second belt arrangement to drive a second elbow pulley on the second linkage, the rotation of the second shoulder pulley and the second elbow pulley causing a rotation of the second linkage out of the way to allow for the extension of the first linkage.

In another example embodiment, a method comprises providing a robot drive comprising a first drive shaft, a second drive shaft, and a third drive shaft, the drive shafts being coaxially arranged and each being independently drivable by a respective motor in first and second directions, an arm connected to the robot drive and rotatable about the robot drive, the arm comprising, a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and a second linkage coupled to the robot drive at a second shoulder pulley, the second linkage comprising a second upper arm, a second forearm connected to the second upper arm at a second elbow pulley, a second belt arrangement between the second shoulder pulley and the second elbow pulley, and a second end effector connected to the second forearm at a second wrist; rotating the first drive shaft in a first direction synchronously with the second drive shaft in the first direction as a function of the rotation of the first drive shaft to drive the first belt arrangement to extend the first linkage from a retracted position; and rotating the third drive shaft synchronously with the second drive shaft in the second direction to cause a rotation of the second linkage, in a retracted position, out of the way of the first linkage, wherein the rotation of the second linkage allows for a clearance of the first linkage relative to the second linkage at the first elbow pulley, simultaneously with an extension of the first linkage.

Rotating the first drive shaft in a first direction synchronously with the second drive shaft in the first direction may comprise rotating the first shoulder pulley to drive the first elbow pulley using the first belt arrangement to cause the extension of the first linkage. Rotating the third drive shaft synchronously with the second drive shaft in the second direction may comprise rotating the second shoulder pulley to cause a rotation of the second linkage, in a retracted position, out of the way of the first linkage, wherein the rotation of the second linkage allows for the simultaneous extension of the first linkage. The arm may be rotated about the drive unit by a simultaneous rotation of the coaxial drive shafts in a desired direction of rotation.

Features as described herein may be provided in an apparatus. Features as described herein may be provided in a method of using an apparatus with features as described above. Features as described herein may be provided in control software, embodied in a memory and capable of use with a processor, or controlling an apparatus with movement as described above.

It should be understood that the foregoing description is only illustrative. Various alternatives and modifications can be devised by those skilled in the art. In addition, features from different embodiments described above could be selectively combined into a new embodiment.

What is claimed is:

1. An apparatus, comprising:
a robot drive comprising a plurality of coaxial drive shafts, each of the coaxial drive shafts being independently driven by a respective motor;
an arm connected to the robot drive and rotatable on the robot drive, the arm comprising,
a first linkage comprising a first upper arm, a first forearm connected to the first upper arm, and a first end effector connected to the first forearm,
the first upper arm connected to a first drive shaft of the coaxial drive shafts at a shoulder joint,
the first forearm connected to a first shoulder pulley on the second drive shaft of the coaxial drive shafts, the first forearm having a first elbow pulley, the first elbow pulley connected to the first shoulder pulley through a first belt drive arrangement, wherein a ratio of diameters of the first shoulder pulley and the first elbow pulley is greater than 2:1, and
the first end effector connected to the first forearm at a first wrist pulley, the first wrist pulley connected to the first upper arm at a second elbow pulley, the first wrist pulley connected to the second elbow pulley through a second belt drive arrangement, wherein a ratio of diameters of the second elbow pulley and the first wrist pulley is 1:2; and
a second linkage comprising a second upper arm, a second forearm connected to the second upper arm, and a second end effector connected to the second forearm,
the second upper arm connected to a third drive shaft of the coaxial drive shafts at the shoulder joint,
the second forearm connected to a second shoulder pulley on the second drive shaft of the coaxial drive shafts, the second forearm having a third elbow pulley, the third elbow pulley connected to the second shoulder pulley through a third belt drive arrangement, wherein a ratio of diameters of the second shoulder pulley and the third elbow pulley is 2:1, and
the second end effector connected to the second forearm at a second wrist pulley, the second wrist pulley connected to the second upper arm at a fourth elbow pulley, the second wrist pulley connected to the fourth elbow pulley through a fourth belt drive arrangement, wherein a ratio of diameters of the fourth elbow pulley and the second wrist pulley is 1:2; and
a controller configured to control the respective motors driving the coaxial drive shafts, wherein the respective motors are controlled to drive the coaxial drive shafts to cause the second linkage, in a retracted position, to be rotated at a same time as the first linkage is extended.

2. The apparatus of claim 1, wherein the coaxial drive shafts are configured such that a synchronized rotation of the first drive shaft in a first direction with the second drive shaft in the first direction as a function of the rotation of the first drive shaft, with a rotation of the third drive shaft in synchronization with the second drive shaft, causes a rotation of the second linkage, in a retracted position, about the drive unit, out of the way of the first linkage, to allow for an extension of the first linkage.

3. The apparatus of claim 2, wherein a rotation of the third drive shaft in a second direction opposite the first direction while maintaining the first drive shaft and the second drive shaft stationary causes the second linkage to extend while the first linkage is extended.

4. The apparatus of claim 1, wherein the arm is configured to be rotated about the drive unit by a simultaneous rotation of the coaxial drive shafts in a desired direction of rotation.

5. The apparatus of claim 1, wherein the first end effector comprises a first wrist plate connected to the first forearm at the first wrist pulley, and wherein the second end effector comprises a second wrist plate connected to the second forearm at the second wrist pulley.

6. The apparatus of claim 1, wherein at least one of the first end effector or the second effector comprises a forked configuration to accommodate two or more workpieces.

7. The apparatus of claim 1, wherein at least one of the first end effector or the second end effector comprises a single arm configured to carry a single workpiece.

8. The apparatus of claim 1, wherein links of the first linkage and links of the second linkage are of substantially equal lengths.

9. An apparatus, comprising:
a robot drive comprising a first drive shaft, a second drive shaft, and a third drive shaft, the drive shafts each being coaxially arranged and independently drivable by a respective motor;
an arm connected to the robot drive and rotatable about the robot drive, the arm comprising,
a first linkage comprising a first upper arm, a first forearm connected to the first upper arm, and a first end effector connected to the first forearm,
a second linkage comprising a second upper arm, a second forearm connected to the second upper arm, and a second end effector connected to the second forearm;
at least one processor; and
at least one memory storing instructions that, when executed with the at least one processor, cause the apparatus to:
rotate the first drive shaft in a first direction synchronously with the second drive shaft in the first direction as a function of the rotation of the first drive shaft; and
rotate the third drive shaft synchronously with the second drive shaft, to cause a rotation of the second linkage, in a retracted position, out of the way of the first linkage, wherein the rotation of the second linkage allows for a clearance of the first linkage relative to the second linkage during an extension of the first linkage.

10. The apparatus of claim 9, wherein the instructions, when executed with the at least one processor, cause the apparatus to rotate the third drive shaft in a second direction while maintaining the first drive shaft and the second drive shaft stationary, to cause the second linkage to extend while the first linkage is extended.

11. The apparatus of claim 9, wherein the instructions, when executed with the at least one processor, cause a rotation of the arm about the drive unit by a simultaneous rotation of the coaxial drive shafts in a desired direction of rotation.

12. An apparatus, comprising:
a robot drive comprising a first drive shaft, a second drive shaft, and a third drive shaft, the drive shafts being coaxially arranged and each being independently drivable by a respective motor in first and second directions;
an arm connected to the robot drive and rotatable about the robot drive, the arm comprising,
a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and
a second linkage coupled to the robot drive at a second shoulder pulley, the second linkage comprising a second upper arm, a second forearm connected to the second upper arm at a second elbow pulley, a second belt arrangement between the second shoulder pulley and the second elbow, and a second end effector connected to the second forearm at a second wrist;
at least one processor; and
at least one memory storing instructions that, when executed with the at least one processor, cause the apparatus to:
rotate the first drive shaft in a first direction synchronously with the second drive shaft in the first direction as a function of the rotation of the first drive shaft to drive the first belt arrangement to extend the first linkage from a retracted position; and
rotate the third drive shaft, simultaneously and synchronously with the second drive shaft in the second direction, to cause a rotation of the second linkage, in a retracted position, out of the way of the first linkage, wherein the rotation of the second linkage allows for a clearance of the first linkage relative to the second linkage as the first linkage extends from the retracted position.

13. The apparatus of claim 12, wherein the instructions, when executed with the at least one processor, cause rotation of the first shoulder pulley to drive the first belt arrangement to drive the first elbow pulley on the first linkage, the rotation of the first shoulder pulley and the first elbow pulley causing the extension of the first linkage.

14. The apparatus of claim 13, wherein the instructions, when executed with the at least one processor, cause rotation of the second shoulder pulley to drive the second belt arrangement to drive a second elbow pulley on the second linkage, the rotation of the second shoulder pulley and the second elbow pulley causing a rotation of the second linkage out of the way to allow for the extension of the first linkage.

15. A method, comprising:
providing a robot drive comprising a first drive shaft, a second drive shaft, and a third drive shaft, the drive shafts being coaxially arranged and each being independently drivable by a respective motor in first and second directions, an arm connected to the robot drive and rotatable about the robot drive, the arm comprising, a first linkage coupled to the robot drive at a first shoulder pulley, the first linkage comprising a first upper arm, a first forearm connected to the first upper arm at a first elbow pulley, a first belt arrangement between the first shoulder pulley and the first elbow pulley, and a first end effector connected to the first forearm at a first wrist, and a second linkage coupled to the robot drive at a second shoulder pulley, the second linkage comprising a second upper arm, a second forearm connected to the second upper arm at a second elbow pulley, a second belt arrangement between the second shoulder pulley and the second elbow pulley, and a second end effector connected to the second forearm at a second wrist;
rotating the first drive shaft in a first direction synchronously with the second drive shaft in the first direction as a function of the rotation of the first drive shaft to drive the first belt arrangement to extend the first linkage from a retracted position; and
rotating the third drive shaft synchronously with the second drive shaft in the second direction to cause a rotation of the second linkage, in a retracted position, out of the way of the first linkage, wherein the rotation of the second linkage allows for a clearance of the first linkage relative to the second linkage at the first elbow pulley, simultaneously with an extension of the first linkage.

16. The method of claim 15, wherein rotating the first drive shaft in a first direction synchronously with the second drive shaft in the first direction comprises rotating the first shoulder pulley to drive the first elbow pulley using the first belt arrangement to cause the extension of the first linkage.

17. The method of claim 16, wherein rotating the third drive shaft synchronously with the second drive shaft in the second direction comprises rotating the second shoulder pulley to cause a rotation of the second linkage, in a retracted position, out of the way of the first linkage, wherein the rotation of the second linkage allows for the simultaneous extension of the first linkage.

18. The method of claim 15, wherein the arm is rotated about the drive unit by a simultaneous rotation of the coaxial drive shafts in a desired direction of rotation.
